(19) United States
(12) Patent Application Publication
(10) Pub. No.: US 2024/0095417 A1
(43) Pub. Date: Mar. 21, 2024

(54) METHOD AND APPARATUS FOR SIMULATION OF ARBITRARILY SHAPED MAGNETIC BODY

(71) Applicant: KOREA UNIVERSITY RESEARCH AND BUSINESS FOUNDATION, Seoul (KR)

(72) Inventors: Junghyun HAN, Seoul (KR); Seung-Wook KIM, Seoul (KR)

(73) Assignee: KOREA UNIVERSITY RESEARCH AND BUSINESS FOUNDATION, Seoul (KR)

(21) Appl. No.: 17/766,924

(22) PCT Filed: Feb. 3, 2021
(86) PCT No.: PCT/KR2021/001410

§ 371 Date: Apr. 6, 2022

(30) Foreign Application Priority Data
Feb. 14, 2020 (KR) 10-2020-0018492

(51) Int. Cl. G06F 30/20

(52) U.S. Cl. CPC G06F 30/20

(57) ABSTRACT

Disclosed are simulation method and apparatus of arbitrarily-shaped magnetic materials. According to the present invention, there is provided a simulation apparatus of magnetic materials including a processor; and a memory connected to the processor, wherein the memory stores program instructions executable by the processor to receive information including geometries, poses, and magnetization intensities for a first magnetic material and a second magnetic material consisting of a plurality of polyhedrons and having uniform magnetization inside the polyhedrons, calculate a magnetic vector potential and a magnetic flux density applied to an arbitrary point by the first magnetic material using the input information, and calculate a magnetic force, a magnetic torque, and a mechanical torque received to the second magnetic material by the first magnetic material using the calculated magnetic vector potential and magnetic flux density.

### TECHNICAL FIELD

The present invention relates to simulation method and apparatus of arbitrarily-shaped magnetic materials and to physical simulation method and apparatus of computer graphics.

### BACKGROUND ART

Magnets are frequently used in everyday life, such as refrigerators at home, pushpin magnets in offices, and science classes.

In the field of computer graphics, simulation of magnetic materials has been studied in earnest after Thomaszewski and others.

Recent studies have presented the results of rigid magnet simulation and magnetohydrodynamic simulation.

A magnetic material generates a magnetic field, and may be magnetized by the magnetic field of another magnetic material, and the magnetization and the magnetic field determine a magnetic force and a magnetic torque to allow the magnetic material to move.

As a prior art in simulation of the magnetic material, a technology of the paper “Magnets in Motion” presented at SIGGRAPH Asia, an international conference in 2008, is representative.

In the prior art, an equivalent dipole method (EDM) for sampling a magnetic dipole moment inside the magnetic material is adopted to calculate the magnetic force of the magnetic material.

In the EDM, with respect to ambient magnetic dipole moments m, as one of components of the magnetic field, a magnetic flux density B is as follows:

$$B ( r ) = \frac{{μ}_{0}}{4 π} {\sum }_{i}^{N} ( \frac{3 {r}_{i} ( {r}_{i} \cdot {m}_{i} ) - ( {r}_{i} \cdot {r}_{i} ) {m}_{i}}{{‖ {r}_{i} ‖}^{5}} ) \qquad [ Equation 1 ]$$

wherein, r is an arbitrary point, μₒ is a constant for permeability in vacuum, and rᵢ is a vector from mᵢ to r.

As a result, the magnetic forces F and the magnetic torque T may be defined as follows.

F=∇(m·B) [Equation 2]

T=m×B [Equation 3]

Equations 2 and 3 may be combined with Equation 1 and expressed as Equation for m as follows.

$$F = \frac{{μ}_{0}}{4 π} {\sum }_{i}^{N} [ \frac{- 15 {r}_{i} ( ( m \cdot {r}_{i} ) \cdot ( {m}_{i} \cdot {r}_{i} ) )}{{‖ {r}_{i} ‖}^{7}} + \frac{3 {r}_{i} ( m \cdot {m}_{i} ) + 3 ( m ( {m}_{i} \cdot {r}_{i} ) + {m}_{i} ( {m}_{i} \cdot {r}_{i} ) )}{{‖ {r}_{i} ‖}^{4}} ] \qquad [ Equation 4 ]$$

$$T = \frac{{μ}_{0}}{4 π} {\sum }_{i}^{N} [ \frac{3 ( m \times {r}_{i} ) ( {m}_{i} \cdot {r}_{i} )}{{‖ {r}_{i} ‖}^{5}} - \frac{m \times {m}_{i}}{{‖ {r}_{i} ‖}^{3}} ] \qquad [ Equation 5 ]$$

When penetration occurs between magnetic materials by simulation, rᵢ becomes very short to cause a problem of diverging B, F, and T.

Accordingly, in the prior art using the EDM, there is a problem in that excessive magnetic force and magnetic torque diverge together with the magnetic flux density B generated between magnetic dipole moments.

In addition, the time complexity of the calculation of the magnetic force and the magnetic torque has a limitation that it is very dependent on the sampling rate of the magnetic dipole moment in the magnetic material.

### DISCLOSURE

### Technical Problem

In order to solve the problems of the prior art, an object of the present invention is to provide simulation method and apparatus of arbitrarily-shaped magnetic materials that are robust to penetration between magnetic materials to prevent a magnetic flux density, a magnetic force, and a magnetic torque from diverging and to reduce time complexity.

### Technical Solution

According to an aspect of the present invention, there is provided a simulation apparatus of magnetic materials including a processor; and a memory connected to the processor, wherein the memory stores program instructions executable by the processor to receive information including geometries, poses, and magnetization intensities for a first magnetic material and a second magnetic material consisting of a plurality of polyhedrons and having uniform magnetization inside the polyhedrons, calculate a magnetic vector potential and a magnetic flux density applied to an arbitrary point by the first magnetic material using the input information, and calculate a magnetic force, a magnetic torque, and a mechanical torque received to the second magnetic material by the first magnetic material using the calculated magnetic vector potential and magnetic flux density.

The magnetic vector potential may be calculated by the following Equation.

$$A ( r ) = \frac{{μ}_{0}}{4 π} {\int }_{V} M ( {r}^{′} ) \times \frac{( r - {r}^{′} )}{{‖ r - {r}^{′} ‖}^{3}} {d}^{3} {r}^{′} \qquad [ Equation ]$$

wherein, r is an arbitrary point, V is a volume of the magnetic material, ∂V is the surface of V, p is a polygon of the polyhedral surface, nₚ is a normal vector of p, and μₒ is permeability in vacuum,

$${W}_{p} ( r ) = {\sum }_{e ∈ \partial p} {ω}_{e} ( r ) ( {n}_{p} \times ( {r}_{e} - r ) \cdot {u}_{e} ) - {Ω}_{p} ( r ) ( {r}_{p} - r ) \cdot {n}_{p} ,$$

wherein, e is a line segment of ∂p, which is an edge of p, rₑ and rₚ are arbitrary points of e and p, respectively, and uₑ is a unit vector according to e,

$${ω}_{e} ( r ) = ln \frac{‖ {r}_{1} - r ‖ + ‖ {r}_{2} - r ‖ + ‖ {r}_{1} - {r}_{2} ‖}{‖ {r}_{1} - r ‖ + ‖ {r}_{2} - r ‖ - ‖ {r}_{1} - {r}_{2} ‖} .$$

The magnetic flux density may be calculated by the following Equation.

$$B ( r ) = \frac{{μ}_{0}}{4 π} {\sum }_{p ∈ \partial V} ∇ {W}_{p} ( r ) \times ( M \times {n}_{p} ) \qquad [ Equation ]$$

$$wherein ,$$

$$∇ {W}_{p} ( r ) = {\sum }_{e ∈ \partial p} {ω}_{e} ( r ) ( {n}_{p} \times {u}_{e} ) + {Ω}_{p} ( r ) {n}_{p} .$$

The magnetic force for the second magnetic material may be calculated by the following Equation.

$$\begin{matrix}F = {\int }_{V} f ( r ) {d}^{3} r \\ = {\int }_{V} ∇ ( M \cdot B ( r ) ) {d}^{3} r \\ = {∮}_{\partial V} ( M \cdot B ( r ) ) n ( r ) {d}^{2} r \\ = {\sum }_{p ∈ \partial V} ( M \cdot {\int }_{p} B ( r ) {d}^{2} r ) {n}_{p}\end{matrix} \qquad [ Equation ]$$

The magnetic torque for the second magnetic material may be calculated by the following Equation.

$$\begin{matrix}T = {\int }_{V} t ( r ) {d}^{3} r \\ = {\int }_{V} ( M \times B ( r ) ) {d}^{3} r \\ = M \times {\int }_{V} B ( r ) {d}^{3} r \\ = M \times {\int }_{V} ( ∇ \times A ( r ) ) {d}^{3} r \\ = M \times {∮}_{\partial V} n ( r ) \times A ( r ) {d}^{2} r \\ = M \times {\sum }_{p ∈ \partial V} ( {n}_{p} \times {\int }_{p} A ( r ) {d}^{2} r )\end{matrix} \qquad [ Equation ]$$

The mechanical torque for the second magnetic material may be calculated by the following Equation.

$$\begin{matrix}𝒯 = {\int }_{V} τ ( r ) {d}^{3} r \\ = {\int }_{V} ( r - {r}_{c} ) \times f ( r ) {d}^{3} r \\ = {\int }_{V} ( r - {r}_{c} ) \times ( ∇ ( M \cdot B ( r ) ) ) {d}^{3} r \\ = {\int }_{V} ∇ \times ( ( M \cdot B ( r ) ) ( r - {r}_{c} ) ) {d}^{3} r \\ = {∮}_{\partial V} n ( r ) \times ( ( M \cdot B ( r ) ) ( r - {r}_{c} ) ) {d}^{2} r \\ = {\sum }_{p ∈ \partial V} {n}_{p} \times ( {\int }_{p} ( M \cdot B ( r ) ) ( r - {r}_{c} ) {d}^{2} r )\end{matrix} \qquad [ Equation ]$$

According to another aspect of the present invention, there is provided a simulation method of a magnetic material in an apparatus including a processor and a memory including steps of: receiving information including geometries, poses, and magnetization intensities for a first magnetic material and a second magnetic material consisting of a plurality of polyhedrons and having uniform magnetization inside the polyhedrons; calculating a magnetic vector potential and a magnetic flux density applied to an arbitrary point by the first magnetic material using the input information; and calculating a magnetic force, a magnetic torque, and a mechanical torque received to the second magnetic material by the first magnetic material using the calculated magnetic vector potential and magnetic flux density.

### Advantageous Effects

According to the present invention, there is an advantage in that a magnetic flux density, a magnetic force, and a torque do not diverge even if two magnetic materials are close to each other or penetrate through each other.

### DESCRIPTION OF DRAWINGS

FIG. 1 is a diagram illustrating a configuration of a simulation apparatus of magnetic materials according to an embodiment of the present invention.

FIG. 2 is a diagram of comparing a simulation according to the present embodiment with an EDM in the prior art.

### BEST MODEL

The present invention may have various modifications and various embodiments, and specific embodiments will be illustrated in the drawings and described in detail.

However, the present invention is not limited to specific embodiments, and it should be understood that the present invention covers all modifications, equivalents and replacements included within the idea and technical scope of the present invention.

The present invention relates to a simulation of arbitrarily-shaped magnetic materials, and it is assumed that the simulated magnetic material generally consists of a plurality of polyhedrons that can be expressed as a 3D mesh, and a magnetization intensity M inside the polyhedrons is uniform.

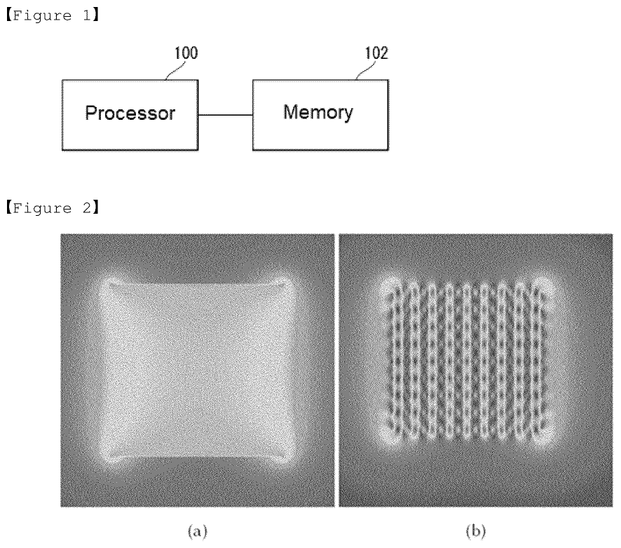

FIG. 1 is a diagram illustrating a simulation apparatus of magnetic materials according to an embodiment of the present invention.

As illustrated in FIG. 1, the simulation apparatus of the magnetic materials according to the embodiment may include a processor 100 and a memory 102.

The processor 100 may include a central processing unit (CPU) capable of executing a computer program, other virtual machines, or the like.

The memory 102 may include a nonvolatile storage device such as a fixed hard drive or a detachable storage device. The detachable storage device may include a compact flash unit, a USB memory stick, etc. The memory 102 may also include volatile memories such as various types of random access memories.

According to an embodiment of the present invention, the memory 102 stores program instructions to receive information including geometries, poses, and magnetization intensities for a first magnetic material and a second magnetic material consisting of a plurality of polyhedrons and having uniform magnetization inside the polyhedrons, calculate a magnetic vector potential and a magnetic flux density applied to an arbitrary point by the first magnetic material using the input information, and calculate a magnetic force, a magnetic torque, and a mechanical torque received to the second magnetic material by the first magnetic material using the calculated magnetic vector potential and magnetic flux density.

Here, the geometry of the magnetic material can be expressed as a 3D polygon mesh, which is a polyhedron, and the mesh consists of information of points and polygons (p) made by connecting the points. The sum of all polygons of the mesh may be referred to as the surface of the magnetic material, and may be expressed as ∂V when the volume of the magnetic material is V.

Hereinafter, the calculation of the magnetic vector potential and the magnetic flux density and the calculation of the magnetic force, the magnetic torque, and the mechanical torque according to the embodiment will be described in detail.

A magnetic vector potential A of the magnetic material may be expressed as follows.

$$A ( r ) = \frac{{μ}_{0}}{4 π} {\int }_{V} M ( {r}^{′} ) \times \frac{( r - {r}^{′} )}{{‖ r - {r}^{′} ‖}^{3}} {d}^{3} {r}^{′} \qquad [ Equation ]$$

A and the magnetic flux density B are related by a curl operator as B=∇×A, and as described above, when M is uniform with respect to the volume of the magnetic material, the magnetic flux density B may be obtained as follows by applying the curl operator of Equation 6.

$$B ( r ) = \frac{{μ}_{0}}{4 π} {\sum }_{p ∈ \partial V} ∇ {W}_{p} ( r ) \times ( M \times {n}_{p} ) \qquad [ Equation 7 ]$$

Here, r is an arbitrary point, V is a volume of the magnetic material, ∂V is the surface of V, p is a polygon of the polyhedral surface, and nₚ is a normal vector of p. In addition, Wₚ and ∇Wₚ are as follows.

$${W}_{p} ( r ) = {\sum }_{e ∈ \partial p} {ω}_{e} ( r ) ( {n}_{p} \times ( {r}_{e} - r ) \cdot {u}_{e} ) - {Ω}_{p} ( r ) ( {r}_{p} - r ) \cdot {n}_{p} \qquad [ Equation 8 ]$$

$$∇ {W}_{p} ( r ) = {\sum }_{e ∈ \partial p} {ω}_{e} ( r ) ( {n}_{p} \times {u}_{e} ) + {Ω}_{p} ( r ) {n}_{p} \qquad [ Equation 9 ]$$

Here, e is a line segment of ∂p, which is an edge of p, and rₑ and rₚ are arbitrary points of e and p, respectively.

In addition, uₑ is a unit vector according to e, and satisfies the following.

$${ω}_{e} ( r ) = ln \frac{‖ {r}_{1} - r ‖ + ‖ {r}_{2} - r ‖ + ‖ {r}_{1} - {r}_{2} ‖}{‖ {r}_{1} - r ‖ + ‖ {r}_{2} - r ‖ - ‖ {r}_{1} - {r}_{2} ‖} \qquad [ Equation 10 ]$$

$$\begin{matrix}{Ω}_{p} ( r ) & = {\sum }_{t ∈ p} {Ω}_{r} ( r ) \\ & = {\sum }_{t ∈ p} 2 arctan \frac{( {r}_{1} - r ) \cdot ( {r}_{2} - r ) \times ( {r}_{3} - r )}{D ( r )}\end{matrix} \qquad [ Equation 11 ]$$

$$D ( r ) = ‖ {r}_{1} - r ‖ ‖ {r}_{2} - r ‖ ‖ {r}_{1} - {r}_{2} ‖ + ‖ {r}_{1} - r ‖ ( {r}_{2} - r ) \cdot ( {r}_{3} - r ) + ‖ {r}_{2} - r ‖ ( {r}_{3} - r ) \cdot ( {r}_{1} - r ) + ‖ {r}_{3} - r ‖ ( {r}_{1} - r ) \cdot ( {r}_{2} - r )$$

In Equation 11, Ωₚ(r) is a solid angle having a sign with respect to p, r₁ and r₁ represent both endpoints of e, respectively, t is one of triangles constituting p, and r₁, r₂, and r₃ are vertices of t.

B calculated through this does not diverge from the inside of the magnetic material.

FIG. 2 is a diagram of comparing a simulation according to the present embodiment and an EDM in the prior art.

FIG. 2A illustrates a simulation result of the magnetic material according to the embodiment, and FIG. 2B illustrates a result of EDM.

Referring to FIG. 2, in the simulation according to the embodiment, divergence does not occur inside the magnetic material, unlike the EDM.

By using A and B calculated as described above, a magnetic force F, a magnetic torque T, and a mechanical torque τ are calculated by converting a volume integral (triple integral) into a surface integral (double integral) as follows.

$$\begin{matrix}F & = {\int }_{V} f ( r ) {d}^{3} r \\ & = {\int }_{V} ∇ ( M \cdot B ( r ) ) {d}^{3} r \\ & = {∮}_{\partial V} ( M \cdot B ( r ) ) n ( r ) {d}^{2} r \\ & = {\sum }_{p ∈ \partial V} ( M \cdot {\int }_{p} B ( r ) {d}^{2} r ) {n}_{p}\end{matrix} \qquad [ Equation 12 ]$$

In Equation 12, the second line is obtained through Equation 2, the third line is obtained through a different form of Gauss's theorem, and the last line is derived by integrating the magnetic force with respect to the polyhedral surface.

Referring to Equation 12, the magnetic material consists of a polyhedron that can be expressed as a 3D mesh, and assuming that M, the magnetization inside the polyhedron, is uniform, it can be seen that the magnetic force is calculated by a simple algebraic calculation instead of a triple integral.

This is the same even with respect to the following magnetic torque and mechanical torque.

$$\begin{matrix}T & = {\int }_{V} t ( r ) {d}^{3} r \\ & = {\int }_{V} ( M \times B ( r ) ) {d}^{3} r \\ & = M \times {\int }_{V} B ( r ) {d}^{3} r \\ & = M \times {\int }_{V} ( ∇ \times A ( r ) ) {d}^{3} r \\ & = M \times {∮}_{\partial V} n ( r ) \times A ( r ) {d}^{2} r \\ & = M \times {\sum }_{p ∈ \partial V} ( {n}_{p} \times {\int }_{p} A ( r ) {d}^{2} r )\end{matrix} \qquad [ Equation 13 ]$$

In Equation 13, the second line is obtained by Equation 3, the fourth line is obtained by the definition of B=∇×A, the fifth line is obtained through another alternative form of Gauss's theorem introduced by Arfken and Weber [2005], and the last line is derived by integrating the torque with respect to a polyhedral surface.

$$\begin{matrix}𝒯 & = {\int }_{V} τ ( r ) {d}^{3} r \\ & = {\int }_{V} ( r - {r}_{c} ) \times f ( r ) {d}^{3} r \\ & = {\int }_{V} ( r - {r}_{c} ) \times ( ∇ ( M \cdot B ( r ) ) ) {d}^{3} r \\ & = {\int }_{V} ∇ \times ( ( M \cdot B ( r ) ) ( r - {r}_{c} ) ) {d}^{3} r \\ & = {∮}_{\partial V} n ( r ) \times ( ( M \cdot B ( r ) ) ( r - {r}_{c} ) ) {d}^{2} r \\ & = {\sum }_{p ∈ \partial V} {n}_{p} \times ( {\int }_{p} ( M \cdot B ( r ) ) ( r - {r}_{c} ) {d}^{2} r )\end{matrix} \qquad [ Equation 14 ]$$

Here, r_{c} represents the center of mass of the magnetic material, the third line is obtained through Equation 2, and the fourth line is obtained through vector identity such as ∇×(ψv)=ψ(∇×v)+∇ψ×v (here, ψ is a scalar and v is a vector).

The fifth line is obtained through another form of Gauss's theorem used in Equation 13, and the last line is derived by integrating with respect to the polyhedral surface.

According to the embodiment, the magnetic material expressed as the polygonal mesh as described above is described. By using the magnetic vector potential A and the magnetic flux density B, the magnetic force, the magnetic torque, and the mechanical torque on the polyhedral surface are integrated with respect to the polyhedral surface.

In this sense, the simulation method of the magnetic materials according to the embodiment is defined as a polyhedral surface method.

In Equations 6 and 7, sampling is not required and is calculated in an O(1) time.

In Equations 12 to 14, the triple integral is reduced to the double integral, and the time complexity is further reduced to O(n²) than O(n⁶) in the conventional EDM.

The embodiments of the present invention described above are disclosed for purposes of illustration, and it will be apparent to those skilled in the art that various modifications, additions, and substitutions are possible within the spirit and scope of the present invention and these modifications, changes, and additions should be considered as falling within the scope of the following claims.

1. A simulation apparatus of magnetic materials comprising:
a processor; and
a memory connected to the processor,
wherein the memory stores program instructions executable by the processor to
receive information including geometries, poses, and magnetization intensities for a first magnetic material and a second magnetic material consisting of a plurality of polyhedrons and having uniform magnetization inside the polyhedrons,
calculate a magnetic vector potential and a magnetic flux density applied to an arbitrary point by the first magnetic material using the input information, and
calculate a magnetic force, a magnetic torque, and a mechanical torque received to the second magnetic material by the first magnetic material using the calculated magnetic vector potential and magnetic flux density.

2. The simulation apparatus of the magnetic material of claim 1, wherein the magnetic vector potential is determined by the following Equation.
$$A ( r ) = \frac{{μ}_{0}}{4 π} {\int }_{V} M ( {r}^{′} ) \times \frac{( r - {r}^{′} )}{{‖ r - {r}^{′} ‖}^{3}} {d}^{3} {r}^{′} \qquad [ Equation ]$$
wherein, r is an arbitrary point, V is a volume of the magnetic material, ∂V is the surface of V, p is a polygon of the polyhedral surface, nₚ is a normal vector of p, and μₒ is permeability in vacuum,
$${W}_{p} ( r ) = {\sum }_{e ∈ \partial p} {ω}_{e} ( {n}_{p} \times ( {r}_{e} - r ) \cdot {u}_{e} ) - {Ω}_{p} ( r ) ( {r}_{p} - r ) \cdot {n}_{p} ,$$
wherein, e is a line segment of ∂p, which is an edge of p, rₑ and rₚ are arbitrary points of e and p, respectively, and uₑ is a unit vector according to e,
$${ω}_{e} ( r ) = ln \frac{‖ {r}_{1} - r ‖ + ‖ {r}_{2} - r ‖ + ‖ {r}_{1} - {r}_{2} ‖}{‖ {r}_{1} - r ‖ + ‖ {r}_{2} - r ‖ - ‖ {r}_{1} - {r}_{2} ‖} .$$

3. The simulation apparatus of the magnetic material of claim 2, wherein
$$B ( r ) = \frac{{μ}_{0}}{4 π} {\sum }_{p ∈ \partial V} ∇ {W}_{p} ( r ) \times ( M \times {n}_{p} ) \qquad [ Equation ]$$
$$wherein , ∇ {W}_{p} ( r ) = {\sum }_{e ∈ \partial p} {ω}_{e} ( r ) ( {n}_{p} \times {u}_{e} ) + {Ω}_{p} ( r ) {n}_{p} .$$

4. The simulation apparatus of the magnetic material of claim 3, wherein the magnetic force for the second magnetic material is calculated by the following Equation.
$$\begin{matrix}F & = {\int }_{V} f ( r ) {d}^{3} r \\ & = {\int }_{V} ∇ ( M \cdot B ( r ) ) {d}^{3} r \\ & = {∮}_{\partial V} ( M \cdot B ( r ) ) n ( r ) {d}^{2} r \\ & = {\sum }_{p ∈ \partial V} ( M \cdot {\int }_{p} B ( r ) {d}^{2} r ) {n}_{p}\end{matrix} \qquad [ Equation ]$$

5. The simulation apparatus of the magnetic material of claim 3, wherein the magnetic torque for the second magnetic material is calculated by the following Equation.
$$\begin{matrix}T & = {\int }_{V} t ( r ) {d}^{3} r \\ & = {\int }_{V} ( M \times B ( r ) ) {d}^{3} r \\ & = M \times {\int }_{V} B ( r ) {d}^{3} r \\ & = M \times {\int }_{V} ( ∇ \times A ( r ) ) {d}^{3} r \\ & = M \times {∮}_{\partial V} n ( r ) \times A ( r ) {d}^{2} r \\ & = M \times {\sum }_{p ∈ \partial V} ( {n}_{p} \times {\int }_{p} A ( r ) {d}^{2} r )\end{matrix} \qquad [ Equation ]$$

6. The simulation apparatus of the magnetic material of claim 3, wherein the mechanical torque for the second magnetic material is calculated by the following Equation.
$$\begin{matrix}𝒯 & = {\int }_{V} τ ( r ) {d}^{3} r \\ & = {\int }_{V} ( r - {r}_{c} ) \times f ( r ) {d}^{3} r \\ & = {\int }_{V} ( r - {r}_{c} ) \times ( ∇ ( M \cdot B ( r ) ) ) {d}^{3} r \\ & = {\int }_{V} ∇ \times ( ( M \cdot B ( r ) ) ( r - {r}_{c} ) ) {d}^{3} r \\ & = {∮}_{\partial V} n ( r ) \times ( ( M \cdot B ( r ) ) ( r - {r}_{c} ) ) {d}^{2} r \\ & = {\sum }_{p ∈ \partial V} {n}_{p} \times ( {\int }_{p} ( M \cdot B ( r ) ) ( r - {r}_{c} ) {d}^{2} r )\end{matrix} \qquad [ Equation ]$$

7. A simulation method of magnetic materials in an apparatus including a processor and a memory, comprising steps of:
receiving information including geometries, poses, and magnetization intensities for a first magnetic material and a second magnetic material consisting of a plurality of polyhedrons and having uniform magnetization inside the polyhedrons;
calculating a magnetic vector potential and a magnetic flux density applied to an arbitrary point by the first magnetic material using the input information; and
calculating a magnetic force, a magnetic torque, and a mechanical torque received to the second magnetic material by the first magnetic material using the calculated magnetic vector potential and magnetic flux density.
